(19) United States
(12) Patent Application Publication
(10) Pub. No.: US 2005/0051603 A1
(43) Pub. Date: Mar. 10, 2005

(54) Process for joining hollow section strips by welding

(76) Inventor: Peter Lisec, Amstetten-Hausmening (AT)

Correspondence Address: YOUNG & THOMPSON, 745 SOUTH 23RD STREET, 2ND FLOOR, ARLINGTON, VA, 22202, US

(21) Appl. No.: 10/923,842

(22) Filed: Aug. 24, 2004

Related U.S. Application Data
(62) Division of application No. 09/850,064, filed on May 8, 2001, now abandoned.

(30) Foreign Application Priority Data
May 9, 2000 (AT) A 808/2000

(51) Int. Cl. B23K 31/02

(52) U.S. Cl. 228/170

(57) ABSTRACT

To prevent formation of a welding bead in the area of the weld on at least one wall when hollow section strips (1) are being joined by butt welding, on at least one wall of the ends of the hollow section strips (1) to be joined to one another by welding, edges (7) are produced which are set back relative to the end faces (5) of the hollow section strips (1) and the ends of the hollow section strips (1) are moved so close to one another in the execution of the welding process that the edges (7) touch and the welding process ends as soon as the edges (7) touch one another.

### CROSS REFERENCE TO RELATED APPLICATIONS

This application is a continuation-in-part of co-pending application Ser. No. 09/850,064, filed on May 8, 2001, the entire contents of which are hereby incorporated by reference.

### FIELD OF THE INVENTION

The invention relates to a process for joining hollow section strips by welding them.

### BACKGROUND OF THE INVENTION

For example, in the production of spacer frames for insulating glass, hollow section strips consisting of aluminum or a thermoplastic are joined to one another into longer units by welding.

In the production of spacer frames for insulating glass which consist of metal, especially aluminum, closing the frame instead by a straight connector inserted into the ends of the hollow section strips by butt welding the ends of a hollow section strip bent into a frame is known.

A device with which this can be done is known from EP 0 192 921 B1 (=U.S. Pat. No. 4,704,512 A).

In the known process for joining hollow section strips by butt welding of the facing end faces of segments of the hollow section strips it is disadvantageous that at the location of the joint a welding bead which projects over the outside contour of the hollow section strip is formed. This welding bead is disruptive especially on the inside surface of a hollow section strip which has been formed into a spacer frame, since it adversely affects the optical impression of the insulating glass pane which has been equipped with this spacer.

In the joining of rods with end disks or nut heads by welding, U.S. Pat. No. 1,004,795 A discloses providing a groove in the end face of the rod so that after the welding process on the outside a welding bead is not visible since the metal which has been displaced in the welding process can be accommodated in the groove.

For butt welding of steel sheet, U.S. Pat. No. 4,912,295 A discloses avoiding deformations of the steel sheet in the edge area by forming the steel sheets sections tapered in the area of the edges which are located transversely to the weld to be produced [sic].

### SUMMARY OF THE INVENTION

The object of the invention is to devise a process for joining hollow section strips by welding in which in the area of the joint on at least one side, especially the side which is the inner side in a spacer frame, there is no visible welding bead.

In the inventive process, before the welding process, on the ends of the hollow section strips to be joined to one another (or the ends of a hollow section strip formed into a frame-like spacer) on at least one surface of the hollow section strip edges are produced which are set back relative to the end faces. Therefore when the hollow section strips are joined or the ends of a hollow section strip are joined to one another, on the side on which there were back-set edges, a weld which is visible from the outside is no longer formed.

It is also advantageous in the inventive process that a coating which is provided anyway on the side of the hollow section strip provided with the set-back edge (varnishing or in aluminum hollow section strips a coating produced by anodizing) remains undamaged also in the area of the weld.

The set-back edge in at least one outside surface of the hollow section strip can be produced in the most varied manner. For example, this edge can be produced by a step or a groove being produced.

There can also be an edge which is set back relative to the end face of the hollow section strip in the end faces of hollow section strips and it can extend for example over the entire height of the side surfaces. In this embodiment of the invention welding beads are avoided not only on the side which lies to the interior in a spacer frame, but also in the area of the side surfaces. This can be advantageous since welding beads which can disrupt the application of adhesive or sealing compounds to the side surfaces of the spacer frame are avoided.

### BRIEF DESCRIPTION OF THE DRAWINGS

Other details, features and advantages of the invention result from the following description of one embodiment of the inventive process using the drawings.

FIG. 1 shows a weld which has been produced using a known process and which joins the ends of the hollow section strips (or the ends of a hollow section strip bent into a frame),

FIG. 2 shows the ends of a hollow section strip prepared for executing the inventive process in an oblique view,

FIG. 3 shows in a lengthwise section the ends of hollow section strips prepared for executing the inventive process,

FIG. 4 shows in a lengthwise section the hollow section strips after connection by welding,

FIG. 5 shows a modified embodiment for producing a set-back edge,

FIG. 6 shows the ends if a hollow profile and a U-shaped insert prepared for executing another embodiment of the inventive process,

FIG. 7 shows the beginning of the welding action in which the two ends of the profile approach each other,

FIG. 8 shows a cross-section with a protective gas cushion, and

FIG. 9 shows a final result of the welding process.

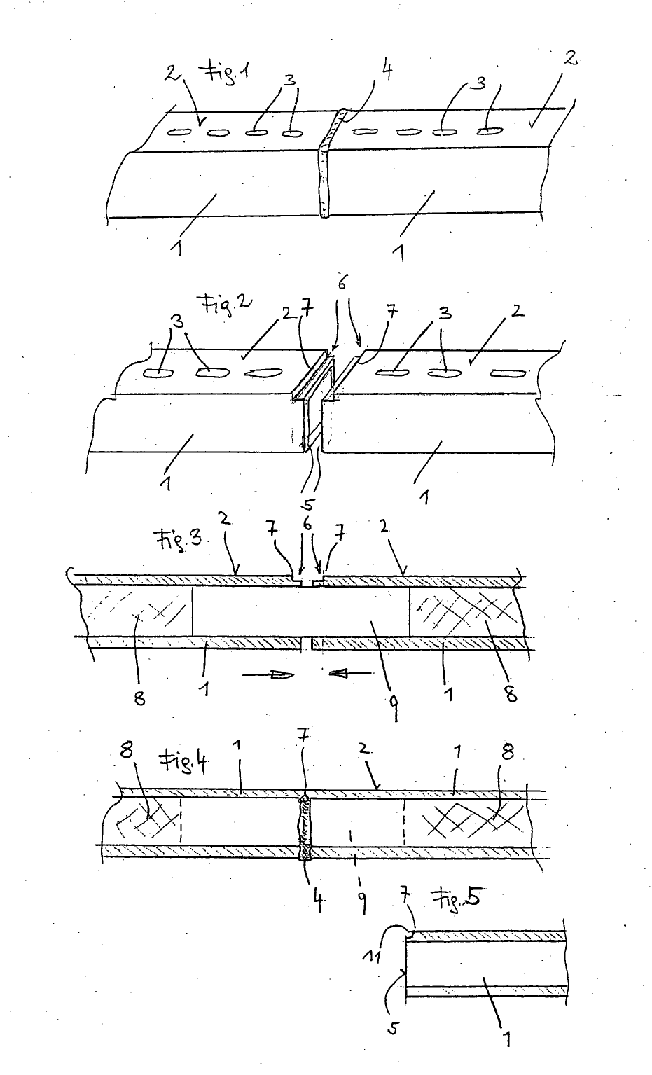

### DETAILED DESCRIPTION OF THE INVENTION

When the ends of two hollow section strips 1 or the ends of one hollow section strip 1 which has been formed into a frame-like spacer for insulating glass are joined to one another by welding using the known process, in the area of the weld on the hollow section strip 1 a disruptive weld 4 which is visible from the outside is formed. This weld 4 is disruptive especially for frame-like spacers for insulating glass which are made of hollow section strips 1 since it can be seen on the surface 2 of the hollow section strips 1 which form the inside of the space frame (this surface is conventionally provided with openings 3 in order for the hygroscopic material added to the hollow section strip to take effect) since this surface 2 is visible in the finished insulating glass.

In the inventive process, the ends of the hollow section strip 1 to be joined to one another, when the ends of the hollow section strip 1 which are bent into a frame-like spacer are to be joined to one another, or the ends of two hollow section strips 1 which are to be joined to one another by welding in order to form a longer hollow section strip, before executing the welding process are each provided with an edge 7 which is set back relative to the end faces 5. These edges 7 are produced at least in the surface 2 which forms the inner surface in the spacer frame. The edges 7 extend over the entire width of the surface 2 of the hollow section strip 1.

In the embodiment shown in FIG. 2, the set-back edges 7 are produced by producing steps 6 in the wall of the hollow section strip 1 which forms the inner surface 2. These steps 6 can be produced by plastic deformation or preferably by removal of material (milling or the like). In any case, it is significant that before the welding process at least in the area of the surfaces 2 which will form or which are already forming the inside of the spacer frame, there are edges 7 which are set back relative to the end faces 5 which are to be joined to one another.

FIG. 3 shows in a lengthwise section the situation from FIG. 2 before executing the welding process for joining the ends of hollow section strips 1 or one hollow section strip 1.

FIG. 3 also shows that a stopper 9, for example made of plastic, is inserted into the ends of the hollow section strip(s) 1 and prevents the hygroscopic material 8 (desiccant) added to the hollow section strip 1 from leaking out. This is important when the ends of a hollow section strip 1 which is already filled with desiccant and formed into a spacer frame are to be joined to one another by welding to close the spacer frame.

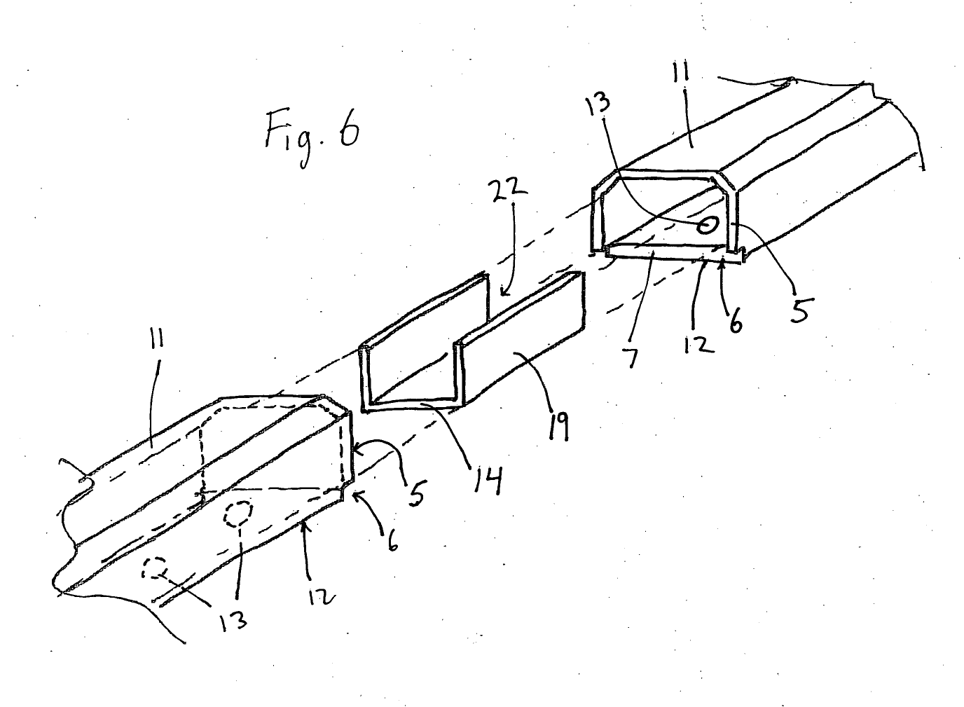

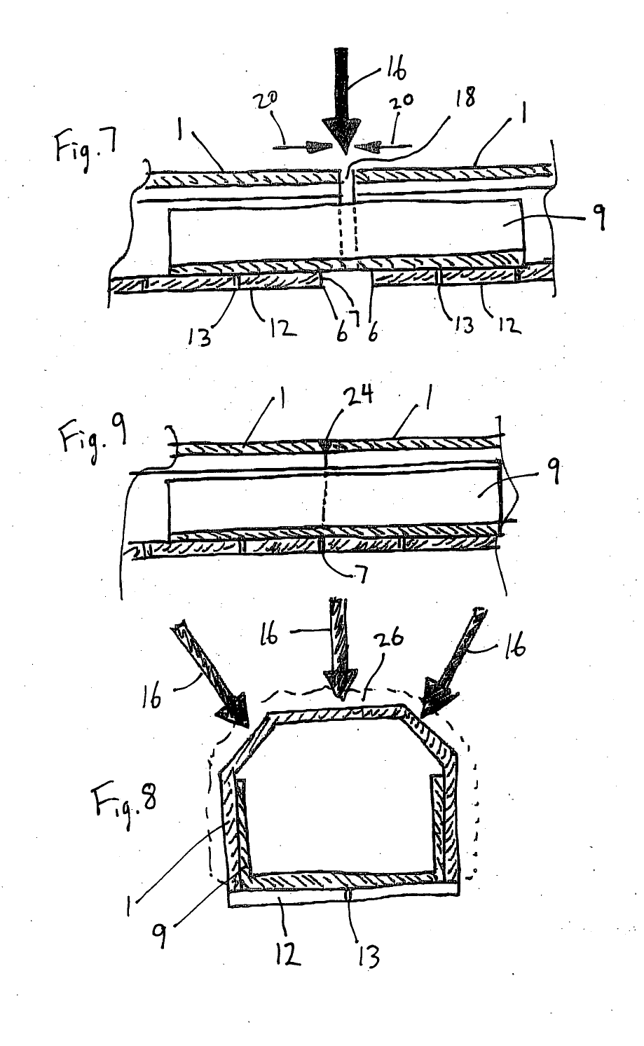

In executing the welding process the ends of the hollow section strip 1 are pressed against one another in the direction of the arrows in FIG. 3 and in the welding process are moved so close one another that the edges 7 which are set back originally relative to the end faces 5 adjoin one another at the end of the welding process. Here, in the area of the edges 7, therefore in the area of the surface 2 of the hollow section strips 1, there is no welding bead visible from the outside (compare FIG. 4).

In the invention therefore the motion of the ends of the hollow section strip 1 or the hollow section strip(s) 1 to be welded to one another towards one another and the welding are stopped as soon as the edges 7 touch.

FIG. 4 shows in a lengthwise section the result of the inventive welding process for joining the ends of two hollow section strips 1 (or a hollow section strip 1 in a spacer frame). It can be seen that the edges 7 adjoin one another and that a welding bead is not visible there from the outside.

In principle it is irrelevant for the inventive process how the edges 7 which are set back over the end faces 5 of the hollow section strips 1 to be joined to one another are made. In addition to the steps 6 shown in FIGS. 2 and 3 the wall of the hollow section strip 1 which forms the surface 2 can also be provided with a groove 11 (FIG. 5).

For reliable joining of hollow section strips 1 or a hollow section strip 1 bent into a spacer frame using the inventive process it is advantageous if the end face 5 of the hollow section strip(s) 1 is made narrower in the area of the set-back edges 7, but still remains, so that in the area of the wall which forms the surface 2 reliable joining of the hollow section strip(s) 1 is achieved.

If welding beads are also to be avoided in the area of the side surfaces of the hollow section strip(s) 1 there can be edges 7 which are set back relative to the end faces 5 in the side surfaces of the hollow section strip(s) 1 as well. These edges 7 extend over the entire height of the side surfaces.

In principle, various measures are conceivable for making the edges which are set back relative to the end faces 5 on the ends of the hollow section strip(s) 1 to be joined to one another. Edges which are formed by steps 6 (FIG. 3) or grooves 11 (FIG. 5) have proven especially advantageous for the successful execution of the inventive process.

The inventive process was described above using the example of joining hollow section strips of metal, especially aluminum. Basically the inventive process can also be used for joining hollow section strips of weldable plastic, especially thermoplastic. When hollow section strips of thermoplastic are joined there will be no “welding bead” either due to the edge which is set back on at least one surface after the welding process in the area of this surface, but this surface will be continuous, therefore flat in the area of this weld as well.

In summary, one embodiment of the invention can be described as follows:

To prevent formation of weld beads in the area of the weld on at least one wall in the joining of hollow section strips 1 by butt welding, on at least one wall of the ends of the hollow section strips 1 to be joined to one another by welding, edges 7 are produced which are set back relative to the end faces 5 of the hollow section strips 1 and the ends of the hollow section strips 1 in the execution of the welding process are brought so near one another that the edges 7 touch and the welding process ends as soon as the edges 7 touch one another.

In a process to join ends of tubular profiles (or of a single tubular profile but to a spacer frame for insulating glass panes) together in the production of a spacer frame the tubular members are joined in a welding operation by carrying out the following step:

Firstly two ends of tubular profiles 11 of metal (in particular aluminum or steel) are machined to (completely) remove a portion of the wall 12 of the hollow profile 11 which in a finished spacer frame will be the wall of the hollow profile facing into the interior of an insulating glass pane. This wall 12 is a wall 12 of the hollow profile 11 which has a number of openings 13 therein (slots) so that desiccating material 8 within the hollow profiles 11 may develop its water absorbing activity in a finished insulating glass pane.

The two ends of the tubular profiles 11 to be joined together may be ends of a tubular profile bent to a spacer frame or the ends of straight profiles 11 to be joined together.

Prior to the welding action carried out for example by electric arc welding, an U-shaped member 19 is inserted into both ends of the tubular profiles to be joined together. This U-shaped member is inserted such that its open side 22 faces to the wall of the hollow profiles 11 which later in a spacer frame of insulating glass is facing to the outside of the insulating glass pane, whereas the stay 14 of the U-shaped member 9 abuts against the interior side of the perforated wall 12 of the hollow profile 11 which wall 12 later on is the wall facing to the inside of the insulating glass pane.

During the welding action, a protecting gas symbolized by arrows 16 (for example nitrogen) is blown into the gap 18 between the two ends of the hollow profiles 11 which during the welding action are approached to each other (arrows 20). The protective gas creates a cushion 26 of protective gas avoiding oxidizing of the metal during the welding action itself.

During the welding action the two ends of the profiles 11 are approached to each other (arrows 20) in order to create a welded joint 24 until the steps 6 created by machining off the inside wall 12 of the hollow profile (perforated wall 12 facing to the interior of the insulating glass pane) abut each other.

Since no protective gas is in the area of the inside wall 12 of the hollow profile 11 no welding takes place on the inside wall 12 of the hollow profile 11 rather the two opposed faces of the inside wall simply abut onto each other.

The steps are shown in FIG. 6 to 9 as follows:

FIG. 6 shows the two ends of the hollow profile 11 machined to create steps 6 and the U-shaped member 9 prior to inserting the U-shaped member 9 into the hollow profiles 11 and approaching those to each other,

FIG. 7 shows the beginning of the welding action in which the two ends of the profiles are approached to each other,

FIG. 8 shows a cross section which symbolized protective gas cushion 26 and

FIG. 9 shows the final result of the process with welds 24 on all walls of the hollow profiles now joined together by welding except for the wall 12 being the inner side of a spacer frame for insulating glass panes.

1. A process for joining the ends of hollow metal profiles for insulating glass panes to one another by welding, comprising the steps of:
completely removing a portion of one wall of each of the ends to be joined to one another to form an edge, said one wall is a wall facing into an interior of an insulating glass pane, each said edge extending over a width of said one wall, each said edge is set back relative to a respective face surface of the ends;
placing respective ends of an insert into each of the ends of the hollow metal profiles to be joined to one another; and
moving the respective face surface of the ends toward one another during the welding process until the edges touch one another, so that said ends are welded together and said edges touch one another without being welded to one another.

2. The process as claimed in claim 1, further comprising the step of forming a plurality of openings in said one wall.

3. The process as claimed in claim 2, further comprising the step of placing a hygroscopic material into each of the ends of the hollow metal profiles prior to the step of placing the insert.

4. The process as claimed in claim 1, wherein said insert is substantially U-shaped and a base of the U faces said one wall.

5. The process as claimed in claim 1, further comprising the step of flowing a gas into a gap formed between the ends prior to the ends being moved together and continuing to flow the gas until welding is complete.

6. The process as claimed in claim 5, wherein said gas in nitrogen.

7. The process as claimed in claim 5, wherein the insert covers the edges during welding so that the gas does not oxidize the edges.

8. The process as claimed in claim 1, wherein the edges are produced by cutting metal from the walls of the hollow metal profiles.

9. The process as claimed in claim 1, wherein the metal hollow profiles are aluminum.

10. A process for joining first and second ends of a hollow metal frame to one another to produce a spacer frame for insulating glass, the process comprising the steps of:
producing an edge which extends over a width of only one wall of each said first and second ends to be joined to one another, said one wall facing into an interior of an insulating glass pane, each said edge being laterally outwardly displaced with respect to a respective face of said first and second ends;
placing respective ends of a substantially U-shaped stopper element into each of the ends of the hollow metal frame to be joined to one another;
placing the respective faces opposing one another to form a gap between respective faces;
blowing nitrogen into said gap to prevent oxidation of the metal during welding;
moving the first and second ends towards one another while butt welding the first and second ends together until each said edge touches one another;
stopping said butt welding and said nitrogen blowing as soon as each said edge touches one another,
wherein said insert prevents the nitrogen gas from contacting said edges so that said edges oxidize during welding and abut each other without being welded.

11. A process for joining first and second ends of a hollow metal frame to one another to produce a spacer frame for insulating glass, the process comprising the steps of:
producing an edge which extends over a width of a first wall of each said first and second ends to be joined to one another, said first wall facing into an interior of an insulating glass pane, each said edge being laterally outwardly displaced with respect to a respective face of said first and second ends;
placing respective ends of a substantially U-shaped stopper element into each of the ends of the hollow metal frame to be joined to one another;
creating a blanket of gas around walls other than said first wall to prevent oxidation of said other walls during welding;
moving the first and second ends towards one another while butt welding the first and second ends together until each said edge touches one another;
stopping said butt welding and removing said blanket of gas as soon as each said edge touches one another so that said edges abut each other without being welded to each other.

12. The process as claimed in claim 11, wherein said gas is nitrogen.

13. The process as claimed in claim 12, wherein said nitrogen blanket is created prior to said first and second ends contacting each other.

14. The process as claimed in claim 13, wherein said edges are produced by machining.
